(19) United States
(12) Patent Application Publication
(10) Pub. No.: US 2024/0283875 A1
(43) Pub. Date: Aug. 22, 2024

(54) APPARATUS, SYSTEM, AND NON-TRANSITORY RECORDING MEDIUM

(71) Applicant: Ken Kubota, KANAGAWA (JP)

(72) Inventor: Ken Kubota, KANAGAWA (JP)

(73) Assignee: Ricoh Company, Ltd., Tokyo (JP)

(21) Appl. No.: 18/581,799

(22) Filed: Feb. 20, 2024

(30) Foreign Application Priority Data
Feb. 22, 2023 (JP) 2023-026123

(51) Int. Cl. H04N 1/00; B41J 3/407; G06F 21/32

(52) U.S. Cl. CPC H04N 1/00076; B41J 3/4073; G06F 21/32; H04N 1/00344

(57) ABSTRACT

An apparatus includes a display, and circuitry to receive operation from an operator, determine an attribute of the operator, and display on the display a notification content relating to a state of a consumable that is used in the apparatus in accordance with the attribute of the operator.

### CROSS-REFERENCE TO RELATED APPLICATIONS

This patent application is based on and claims priority pursuant to 35 U.S.C. § 119(a) to Japanese Patent Application No. 2023-026123, filed on Feb. 22, 2023, in the Japan Patent Office, the entire disclosure of which is hereby incorporated by reference herein.

### BACKGROUND

### Technical Field

The present disclosure relates to an apparatus, a system, and a non-transitory recording medium.

### Related Art

An apparatus such as an image forming apparatus is properly maintained so that the function of the apparatus is not impaired. Examples of the maintenance include replenishment and replacement of consumables that are used in the apparatus. The consumables vary depending on the apparatus. Examples of the consumables include toner, ink, a lubricant of a part, and a part (roller or the like) that is worn over time. The administrator desirably orders a consumable in advance to avoid occurrence of downtime that is a period in which the apparatus is not available.

A technique of preventing the downtime of an apparatus, which occurs because a consumable is not properly prepared, is known. For example, there is a technique of performing control to a consumable consumption reduction mode after a consumable remaining amount detection mechanism detects the near end of a consumable.

### SUMMARY

According to an embodiment of the present disclosure, an apparatus includes a display; and circuitry that receives operation from an operator, determines an attribute of the operator, and displays on the display a notification content relating to a state of a consumable that is used in the apparatus in accordance with the attribute of the operator.

According to an embodiment of the present disclosure, a system includes an apparatus that uses a consumable; and an information processing apparatus that communicates with the apparatus and receives an operation of an operator on the apparatus. The apparatus includes a display; and circuitry that determines an attribute of the operator, and displays on the display a notification content relating to a state of the consumable that is used in the apparatus in accordance with the attribute of the operator.

According to an embodiment of the present disclosure, a non-transitory recording medium storing a plurality of instructions which, when executed by one or more processors, causes the one or more processors to perform a display method. The method includes receiving operation from an operator; determining an attribute of the operator; and displaying on a display a notification content relating to a state of a consumable that is used in the apparatus in accordance with the attribute of the operator.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view illustrating an example of a warning in one line indicating the near end of toner;

FIGS. 2A and 2B are a flowchart and a diagram schematically presenting an example of a process in which an apparatus makes a notification of the near end of a consumable;

FIGS. 3A to 3C are diagrams illustrating examples of configurations of the apparatus and an apparatus system (“system”);

FIG. 4 is an enlarged view illustrating an example of an operation panel;

FIG. 5 is a block diagram illustrating a hardware configuration of an image forming apparatus that is an example of the apparatus;

FIG. 6 is a block diagram illustrating a hardware configuration of an example of a terminal apparatus;

FIG. 7 is a block diagram illustrating an example of a functional configuration of the apparatus;

FIG. 8 is a table presenting an example of attribute information stored in an attribute information storage unit;

FIG. 9 is a table presenting an example of notification management information stored in a notification management information storage unit;

FIG. 10 is a view illustrating an example of the position of a camera lens included in a camera disposed in an operation panel;

FIG. 11 is a flowchart presenting an example of a process in which a detection unit determines the near end of a consumable;

FIG. 12 is a flowchart presenting an example of a process in which a controller performs display relating to the near end of a consumable of the apparatus;

FIG. 13 is a view illustrating an example of a notification screen of the near end of a consumable displayed for an administrator;

FIG. 14 is a view illustrating an example of a notification screen of the near end of a consumable displayed for a general user;

FIG. 15 is a flowchart presenting an example of a process in which the controller restricts notification of the near end of the consumable for the same general user;

FIG. 16 is a diagram illustrating an example of screen transition of screens displayed by the apparatus;

FIG. 17 is a diagram illustrating an example of screen transition when the notification of the near end of the consumable for the same general user is restricted;

FIG. 18 is a block diagram illustrating an example of a functional configuration of an apparatus and a terminal apparatus;

FIG. 19 is a sequence diagram presenting an example of a process in which the terminal apparatus displays a near end notification of a consumable notified from the apparatus;

FIG. 20 is a view illustrating an example of a notification screen displayed in a pop-up form in a superimposed manner on a printer driver displayed by the terminal apparatus when a logged-in operator is an administrator;

FIG. 21 is a view illustrating an example of a notification screen displayed in a pop-up form in a superimposed manner on the printer driver displayed by the terminal apparatus when the logged-in operator is a general user;

FIG. 22 is a diagram illustrating an example of a configuration of an apparatus system;

FIG. 23 is a functional block diagram illustrating an example of a functional configuration of the apparatus system in FIG. 22;

FIG. 24 is a sequence diagram presenting an example of a process in which the terminal apparatus displays a near end notification of a consumable notified from a robot control apparatus; and

FIG. 25 is a diagram illustrating an example of a configuration of an apparatus system when a three-dimensional (3D) printer is employed.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a” “an”, and “the” are intended to include the plural forms as well, unless the context clearly indicates otherwise.

An apparatus and an information display method performed by the apparatus are described below as examples of embodiments to implement the present disclosure.

### First Embodiment

### Overview of Display of Near End of Consumable

To avoid occurrence of downtime in which an apparatus is not available, an administrator orders a consumable at proper timing. In a case of an apparatus connected to a network, the near end of a consumable detected by the apparatus is notified to a server on the network, and the server automatically orders the consumable from a customer center or the like.

However, in a case of an apparatus not connected to the network, even when the apparatus detects the near end of a consumable, the consumable is not automatically ordered. Even when the apparatus is connected to the network, in a case of a customer who does not make a contract for automatically ordering a consumable, the consumable is not automatically ordered.

When the consumable is not automatically ordered, the administrator recognizes the near end detected by the apparatus, checks the stock state of the consumable, and makes an order. The apparatus has a function of transmitting the near end of the consumable using an operation panel or an email. For example, the apparatus has a function of displaying a warning in one line indicating the near end of the consumable on an upper portion of the operation panel to notify a user of the near end.

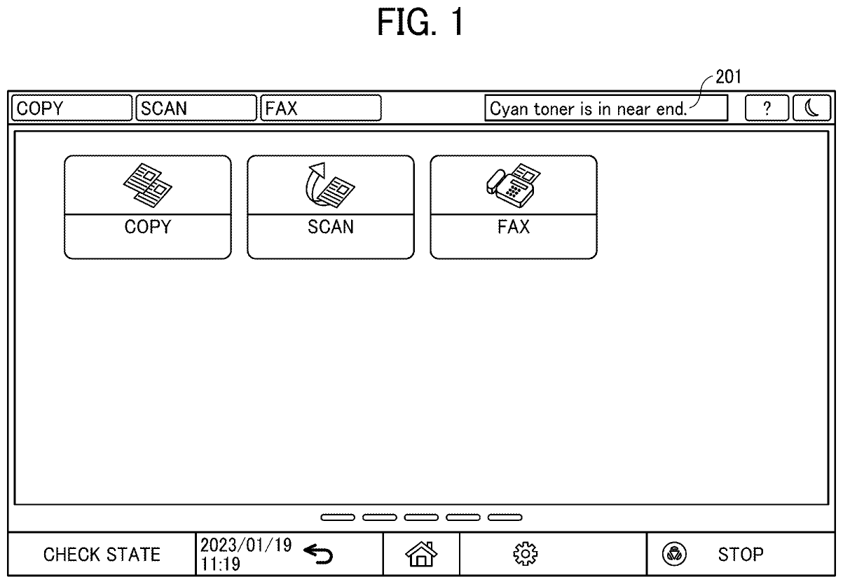

FIG. 1 is a view illustrating an example of a warning 201 in one line indicating the near end of toner. As illustrated in FIG. 1, even when the warning 201 such as “Cyan toner is in near end.” is displayed, the warning 201 may be overlooked or the significance may be unnoticed by the administrator because the warning 201 is small with respect to the screen. Thus, the administrator may order a part to be used in a state in which the apparatus is no longer available (end state of toner). In this case, downtime occurs.

In the state in which the toner is in the near end, the apparatus may display that the toner is in the near end largely on the screen in a pop-up form similarly to a situation of the end state. However, usability may be lowered because the screen is hidden by the pop-up.

Thus, in the present embodiment, an apparatus captures an image of the face of a logged-in operator using a camera or the like, and determines whether the operator is an administrator. The administrator is responsible for maintaining the apparatus, and hence the apparatus notifies the administrator of the near end by display in a pop-up form or the like without exception. When the operator is other than the administrator, the apparatus displays a pop-up instructing the operator to notify the administrator of the near end.

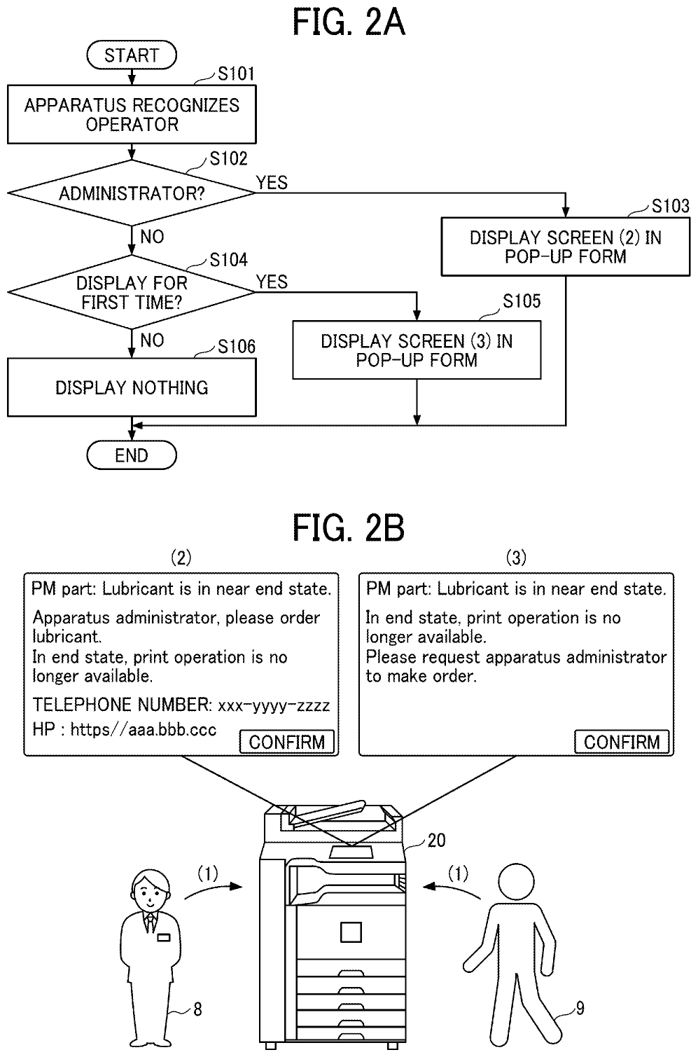

FIGS. 2A and 2B are a flowchart and a diagram schematically presenting an example of a process in which an apparatus 20 makes a notification of the near end of a consumable.

FIG. 2A presents a process performed by the apparatus 20. FIG. 2B illustrates notification screens (messages) displayed by the apparatus 20. The apparatus 20 executes the process in FIG. 2A. It is assumed that the apparatus 20 has learned the image of the face of an administrator in advance.

(1) An operator performs a login operation on the apparatus 20. The apparatus 20 captures an image of the face of the operator and recognizes the image of the face for authentication (S101). Through the authentication, the attribute of the operator (for example, whether the operator is an administrator or a general user) is determined.

(2) The apparatus 20 determines whether the operator is an administrator (S102). When an administrator 8 operates the apparatus 20, the apparatus 20 displays a message “Apparatus administrator, please order lubricant. In end state, print operation is no longer available.” on an operation panel (an example of a displaying unit) (S103).

(3) When the operator is a general user 9, the apparatus 20 determines whether to notify the general user 9 of the near end of the consumable for the first time (S104). In the case of the notification for the first time, the apparatus 20 displays a message “In end state, print operation is no longer available. Please request apparatus administrator to make order.” is displayed on the operation panel (S105).

When the operator is not the administrator and is the general user, and when the display is not the display for the first time, the apparatus 20 does not display the near end of the consumable (S106).

By displaying in a pop-up form the near end of the consumable that the administrator or the general user could not notice with the warning in one line, it is possible to prevent the consumable from becoming the end state and the downtime from occurring. Displaying the near end of the consumable in a pop-up form for the general user leads to lowering usability. However, the apparatus 20 displays the near end of the consumable in a pop-up form once for the general user, thereby preventing the usability from being lowered. Thus, the apparatus 20 of the present embodiment can attain both usability and a reduction in downtime.

### Terminology

The consumable represents a material that is consumed or worn during use and hence is used up or changes to an unusable state soon. Examples of the consumable include those directly used for production of an object, such as toner or ink, and those indirectly used for production of an object, such as a lubricant or a component.

The state of the consumable represents how much the consumable is close to the unusable state. In the present embodiment, a state close to the unusable state is referred to as near end, and the unusable state is referred to as end state. For example, it can be determined that the state has reached the state of the near end when the remaining amount of the consumable has reached a predetermined amount or when the use period of the consumable has reached a predetermined period.

The attribute of the operator is the type of user relating to whether the user is responsible for the state of the consumable, or the degree of the responsibility. In the present embodiment, examples of the attribute include an administrator and a general user. There may be an attribute other than the administrator and the general user.

The administrator is a person who manages an apparatus so that the apparatus can be used without a problem. The administrator is responsible for, for example, ordering the consumable. The administrator may be referred to as a person in charge, a manager, a refill person, or the like. The general user is a person who is not the administrator. However, the administrator may use the apparatus as the general user.

### Examples of Configurations of Apparatus

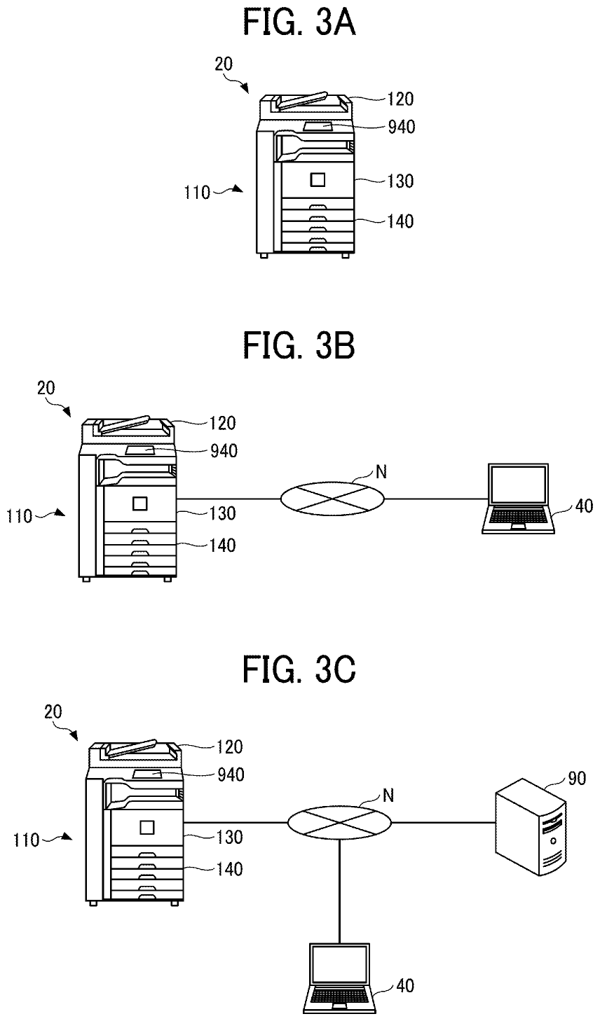

FIGS. 3A to 3C are diagrams illustrating examples of configurations of an apparatus 20 and an apparatus system 100. FIG. 3A is an example of an external view of the apparatus 20. As illustrated in FIG. 3A, the apparatus 20 includes a main body 110, an operation panel 940, a scanner device 120, a printer 130, and a sheet feeder 140.

The main body 110 prints image data obtained by reading a document or a print job received from a personal computer (PC) or the like on a recording medium such as a sheet of paper. The apparatus 20 communicates with the PC via a network and receives a print job from the PC. The main body 110 may perform printing by any printing method, such as an electrophotographic method or an inkjet method.

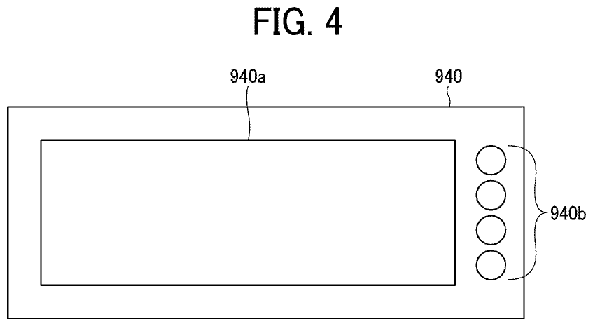

The operation panel 940 allows an operator to input an operation, and displays an operation screen of the apparatus 20, progress states of various jobs, warnings, and so forth. Details will be described with reference to FIG. 4. The position and size of the operation panel 940 illustrated in the drawing are examples, and the operation panel 940 may be disposed at any position of the apparatus 20. In one example, the operation panel 940 may be attachable to and detachable from the main body 110. In one example, the apparatus 20 may communicate with a smartphone or a tablet terminal, and the smartphone or the tablet terminal may be used as the operation panel 940.

The scanner device 120 reads a document fed onto a glass surface by an auto document feeder (ADF) or the like, using a one-dimensional optical element, and generates image data.

For example, the printer 130 generates a toner image of colors including cyan, magenta, yellow, and black (CMYK) in accordance with image data, transfers the toner image on a sheet, and fixes the toner to the sheet with heat and pressure. In one example, the printer 130 may include an inkjet head and print an image on a sheet with ink.

The sheet feeder 140 includes a plurality of sheet trays for storing sheets by size. Image data is to be printed on the sheets. The sheet feeder 140 takes out the sheets in the sheet tray one by one from the upper side under control given from the main body 110, and conveys the sheet to the printer 130 of the main body 110.

FIG. 3B illustrates an example of a configuration of an apparatus system 100 in which the apparatus 20 and a terminal apparatus 40 are communicably connected via a network N.

The terminal apparatus 40 is, for example, an information processing apparatus that is used by an administrator or a general user to operate the apparatus. The terminal apparatus 40 may be any apparatus on which a general-purpose operating system (OS) operates, such as a desktop PC, a notebook PC, a smartphone, or a tablet terminal. The administrator or the general user calls a printer driver or the like from an application and transmits a print job or the like to the apparatus 20.

When the apparatus 20 detects the near end of a consumable, the apparatus 20 transmits the near end of the consumable to the terminal apparatus 40 through communication of the terminal apparatus 40 with the apparatus 20 or through push communication from the apparatus 20. The terminal apparatus 40 can display the near end of the consumable.

In one example, the apparatus 20 may transmit apparatus information such as the remaining amount of toner to the terminal apparatus 40, and the terminal apparatus 40 may determine the near end of the consumable based on the apparatus information. When it is determined that the consumable is in the near end, the terminal apparatus 40 displays the near end of the consumable.

FIG. 3C illustrates an example of a configuration of an apparatus system 100 in which the apparatus 20 and a server apparatus 90 are communicably connected via the network N. In the present embodiment, the apparatus 20 alone can determine the near end of a consumable and display a pop-up. However, the communication between the apparatus 20 and the server apparatus 90 is not restricted.

When the apparatus 20 is communicably connected to the server apparatus 90 via the network N, the apparatus 20 transmits the remaining amount of a consumable to the server apparatus 90. The server apparatus 90 determines whether the state is the near end based on the remaining amount of the consumable. When it is determined that the consumable is in the near end, the server apparatus 90 notifies the apparatus 20 of the near end of the consumable.

If a customer has made a contract for automatic ordering the consumable with a sales company of the consumable, the apparatus 20 does not have to display that the consumable is in the near end. Thus, the apparatus 20 acquires information indicating whether the contract for automatic ordering has been made with the sales company of the consumable from the server apparatus 90, and switches whether to display the near end of the consumable. That is, when the customer has made the contract, the apparatus 20 does not display the near end of the consumable, and when the customer has not made the contract, the apparatus 20 displays the near end of the consumable.

In the present embodiment, description is given using the configuration in FIG. 3A (apparatus 20 alone) unless otherwise particularly mentioned. The configuration in FIG. 3B in which the terminal apparatus 40 and the apparatus 20 communicate with each other will be described in a second embodiment.

FIG. 4 is an enlarged view illustrating an example of the operation panel 940. As illustrated in FIG. 4, the operation panel 940 includes a panel display 940a that is a liquid crystal display (LCD) that is operable using a touch panel, and a hard key set 940b that is operable even when the operation panel 940 is off. In one example, the near end of a consumable is displayed on the operation panel 940.

The hard key set 940b includes assigned keys such as “return”, “home screen display”, and “stop” that are used in common for respective screens to be displayed. In one example, assignment of the functions of the keys included in the hard key set 940b can be changed by customization.

### Example of Hardware Configuration

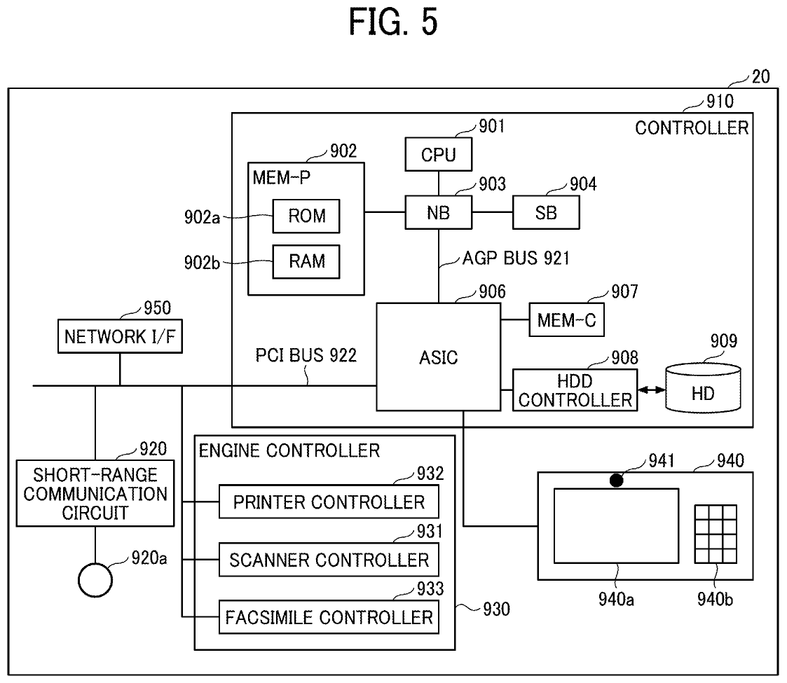

FIG. 5 is a block diagram illustrating a hardware configuration of an image forming apparatus that is an example of the apparatus 20. As illustrated in FIG. 5, the image forming apparatus includes a controller 910, a short-range communication circuit 920, an engine controller 930, an operation panel 940, and a network interface (I/F) 950.

The controller 910 includes a central processing unit (CPU) 901 as a main processor, a system memory (MEM-P) 902, a northbridge (NB) 903, a southbridge (SB) 904, an application specific integrated circuit (ASIC) 906, a local memory (MEM-C) 907 as a storage unit, a hard disk drive (HDD) controller 908, and a hard disk (HD) 909 as a storage unit. The NB 903 and the ASIC 906 are connected through an accelerated graphics port (AGP) bus 921.

The CPU 901 is a controller 21 that controls overall operation of the image forming apparatus. The NB 903 is a bridge for connecting the CPU 901 to the MEM-P 902, the SB 904, and the AGP bus 921, and includes a memory controller that controls reading or writing from or to the MEM-P 902, a peripheral component interconnect (PCI) master, and an AGP target.

The MEM-P 902 includes a read-only memory (ROM) 902a that is a memory for storing a program and data to implement each function of the controller 910, and a random access memory (RAM) 902b that is used as a memory for drawing when developing the program and data and printing data from the memory. In one example, the program stored in the RAM 902b may be provided by being recorded in a computer-readable recording medium such as a compact disk read-only memory (CD-ROM), a compact disk recordable (CD-R), or a digital versatile disk (DVD) in a file of an installable format or an executable format.

The SB 904 is a bridge for connecting the NB 903 to a PCI device or a peripheral device. The ASIC 906 is an integrated circuit (IC) dedicated to an image processing use and including hardware elements for image processing, and connects the AGP bus 921, a PCI bus 922, the HDD controller 908, and the MEM-C 907 to one another. The ASIC 906 includes a PCI target, an AGP master, an arbiter (ARB) as a central processor of the ASIC 906, a memory controller, a plurality of direct memory access controllers (DMACs), and a PCI unit. The memory controller controls the MEM-C 907. The DMACs can rotate image data with a hardware logic. The PCI unit transfers data to a scanner controller 931, a printer controller 932, and a facsimile controller 933 through the PCI bus 922. In one example, the ASIC 906 may include a Universal Serial Bus (USB) interface or an Institute of Electrical and Electronics Engineers 1394 (IEEE 1394) interface.

The MEM-C 907 is a local memory used as a buffer for image data to be copied or a code buffer. The HD 909 stores image data, font data for printing, and form data. The HDD controller 908 reads or writes data from or to the HD 909 under control of the CPU 901. The AGP bus 921 is a bus interface for a graphics accelerator card proposed for speeding up graphic processing, and can speed up the graphics accelerator card by directly making an access to the MEM-P 902 with high throughput.

The short-range communication circuit 920 is provided with a short-range communication circuit antenna 920a. The short-range communication circuit 920 is a communication circuit in compliance with a standard such as near field communication (NFC) or Bluetooth®.

The engine controller 930 includes the scanner controller 931, the printer controller 932, and the facsimile controller 933. The operation panel 940 includes a panel display 940a and a hard key set 940b. The panel display 940a is implemented by, for example, a touch panel that displays current settings or a selection screen to receive an operator input. The hard key set 940b includes a numeric keypad that receives set values of various image forming parameters such as an image density parameter and a start key that receives an instruction for starting copying. The controller 910 controls overall operation of the image forming apparatus. For example, the controller 910 controls drawing, communication, or operator inputs to the operation panel 940. The scanner controller 931 and the printer controller 932 each performs various image processing, such as error diffusion or gamma conversion.

A camera (an example of an imaging unit) is disposed in the operation panel 940. The camera captures an image of an operator in front of a camera lens 941. The camera may be incorporated in the operation panel 940 or may be externally attached to the operation panel 940 using a USB cable or the like. In one example, an IC card reader and a biometric authentication device, such as a fingerprint detector, a palm print detector, or an iris detector, may be connected to the controller 910.

In response to an instruction to select a specific application through the operation panel 940, for example, using a mode switch key, the image forming apparatus selectively performs a document box function, a copy function, a print function, and a facsimile function. When the document box function is selected, the image forming apparatus operates in a document box mode. When the copy function is selected, the image forming apparatus operates in a copy mode. When the print function is selected, the image forming apparatus operates in a print mode. When the facsimile function is selected, the image forming apparatus operates in a facsimile mode.

The network I/F 950 is an interface for performing data communication via the network N. The short-range communication circuit 920 and the network I/F 950 are electrically connected to the ASIC 906 via the PCI bus 922.

### Terminal Apparatus

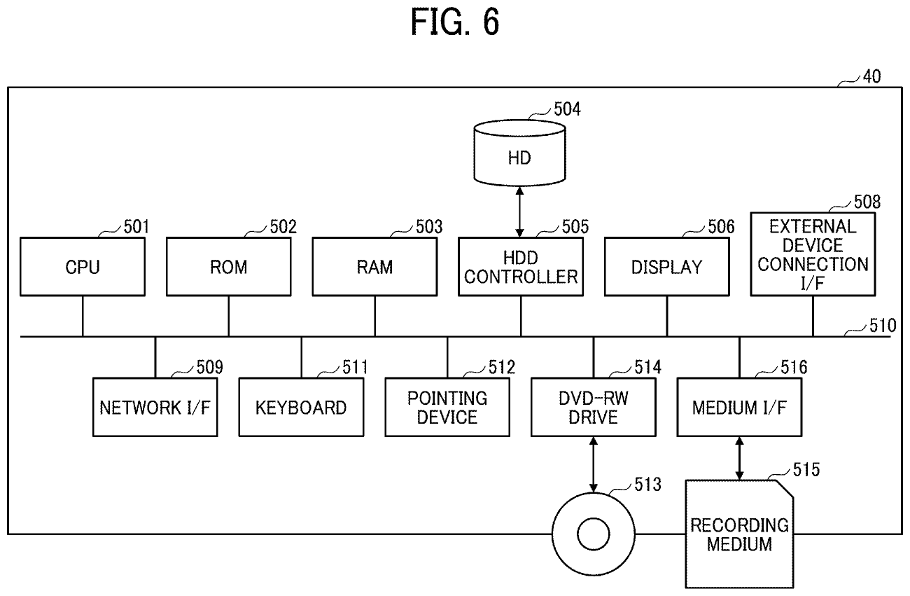

FIG. 6 is a block diagram illustrating an example of a hardware configuration of the terminal apparatus 40. As illustrated in FIG. 5, the terminal apparatus 40 is constructed by a computer and includes a CPU 501, a ROM 502, a RAM 503, a HD 504, a HDD controller 505, a display 506, an external device connection I/F 508, a network I/F 509, a bus line 510, a keyboard 511, a pointing device 512, a digital versatile disk rewritable (DVD-RW) drive 514, and a medium I/F 516.

The CPU 501 controls overall operation of the terminal apparatus 40. The ROM 502 stores programs such as an initial program loader (IPL) to boot the CPU 501. The RAM 503 is used as a work area for the CPU 501. The HD 504 stores various kinds of data such as a program. The HDD controller 505 controls reading or writing of various kinds of data from or to the HD 504 under control of the CPU 501. The display 506 (an example of a displaying unit) displays various kinds of information such as a cursor, a menu, a window, characters, or an image. The external device connection I/F 508 is an interface for connecting various external devices. Examples of the external devices in this case include, but are not limited to, a USB memory and a printer. The network I/F 509 is an interface for performing data communication via the network N. The bus line 510 is, for example, an address bus or a data bus for electrically connecting the components such as the CPU 501 illustrated in FIG. 6 to one another.

The keyboard 511 is an example of an input unit provided with a plurality of keys for allowing an operator to input characters, numerals, or various instructions. The pointing device 512 is an example of an input unit that allows the operator to select or execute a specific instruction, select a target for processing, or move a cursor being displayed. The DVD-RW drive 514 controls reading or writing of various kinds of data from or to a DVD-RW 513 that is an example of a removable recording medium. In one example, a DVD-R may be used instead of the DVD-RW 513. The medium I/F 516 controls reading or writing (storing) of data from or to a recording medium 515 such as a flash memory.

### Functions

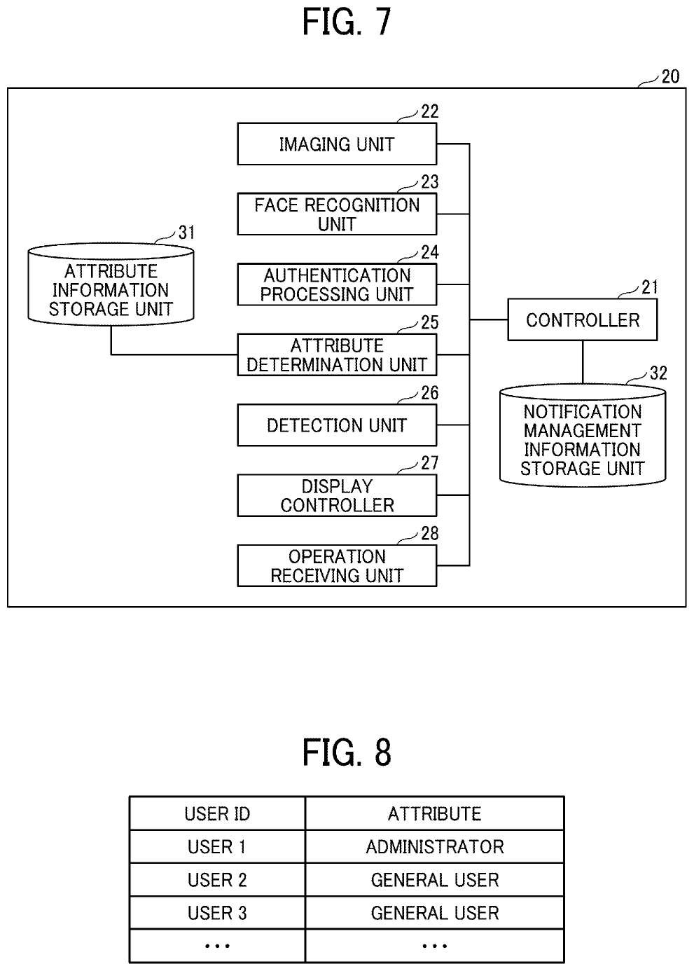

FIG. 7 is a block diagram illustrating an example of a functional configuration of the apparatus 20 according to the embodiment. The apparatus 20 includes a controller 21, an imaging unit 22, a face recognition unit 23, an authentication processing unit 24, an attribute determination unit 25, a detection unit 26, a display controller 27, and an operation receiving unit 28. The functional units included in the apparatus 20 are functions or units that are implemented by the CPU 901 executing commands included in one or more programs installed in the apparatus 20. In one example, part or all of the functions of the apparatus 20 may be implemented by hardware such as an IC circuit, an ASIC, or a field programmable gate array (FPGA). The functions illustrated in FIG. 7 mainly indicate major functions of the apparatus 20 of the embodiment. The apparatus 20 may have a print function, a scan function, and a facsimile function in addition to the functions illustrated in FIG. 7.

The controller 21 controls overall operation of the apparatus 20. The controller 21 performs transition to and return from an energy saving state, calling of a function of the apparatus 20, and turning on/off of the power supply. The controller 21 calls each function for displaying the near end of a consumable, and performs control in accordance with the processing result of the function.

The imaging unit 22 forms an image of rays from a subject on a solid-state imaging element, such as a charge-coupled device (CCD) or a complementary metal-oxide semiconductor (CMOS), using an optical system such as a lens, and photoelectrically converts the brightness of the image with light into the amount of charge. The imaging unit 22 sequentially reads voltage values obtained by photoelectric conversion on a pixel basis to generate image data for a sheet.

The imaging unit 22 captures an image at a predetermined angle of view so that the face is included at least when an administrator (or a general user) operates the operation panel 940. The imaging unit 22 may normally capture an image at a predetermined angle of view during startup (when the power is on and the state is not in the energy saving state), may capture an image when the administrator or the general user approaches, or may capture an image when the administrator or the general user logs in.

The face recognition unit 23 performs face recognition from image data generated by the imaging unit 22 capturing an image.

The face recognition unit 23 has registered therein at least a feature of an image of the face of an administrator, and detects the feature from the image data to determine whether the operator is the administrator. When the face recognition unit 23 has registered therein a feature of an image of the face of a general user, the face recognition unit 23 can individually identify the general user by detecting the feature from the image data. Thus, face recognition is one type of biometric authentication.

Features of the image of the face include distances between face parts, such as the 10 eyes, the nose, and the corners of the mouth. Although an operation such as input of a user ID and a password, input of biometric authentication information such as a fingerprint, or touch of an IC card has been used in related art to log in to the apparatus 20, the time and effort of the operation can be reduced. Any authentication method may be used in the present embodiment.

When the face recognition unit 23 identifies that the operator is an administrator or a general user, login is permitted in the same manner as when the authentication by the authentication processing unit 24 is successful. When the face recognition unit 23 can recognize the image of the face of only the administrator, login does not have to be permitted. The face recognition unit 23 notifies the attribute determination unit 25 of whether the operator is the administrator.

In one example method, the face recognition unit 23 may perform pattern matching using an image of the face of an administrator or a general user registered in advance. In another example method, the face recognition unit 23 may recognize an image of the face of an administrator or a general user through deep learning. Deep learning is an algorithm that predicts an output value using a neural network or the like based on input data and then adjusts weights between neural networks by backpropagation to reduce an error between the output value and training data. In face recognition using deep learning, a learning device uses images of the faces of a plurality of administrators and images of the faces not of the plurality of administrators as training data. Specifically, the learning device inputs pixel values of the images of the faces, and learns correspondence between the training data indicating the administrators and the images of the faces, using the training data indicating the image of the administrator.

There is also an algorithm called a boosting decision tree. The boosting decision tree is one of supervised learning in which “boosting (ensemble)” and “decision tree” are combined. Although the details of the boosting decision tree are known, the boosting decision tree is an algorithm in which a plurality of weak discriminators independently perform learning, prediction results by the plurality of weak discriminators are integrated using weighted majority voting or the like, and the integrated prediction result is output as a prediction result of the entirety (strong discriminator). Methods of machine learning include perceptron, support vector machine, logistic regression, Naive Bayes, random forest, and so forth, and the method of learning is not limited to the method described according to the present embodiment.

The authentication processing unit 24 performs the input of a user ID and a password, the user authentication using an IC card, or the user authentication using biometric authentication information described above. The authentication processing unit 24 may be included in an authentication server connected via a network instead of the apparatus 20.

The attribute determination unit 25 manages an attribute (for example, whether the operator is an administrator or a general user) for each user, and determines whether the operator recognized by the face recognition unit 23 or the operator determined by the authentication processing unit 24 as being successful in authentication is an administrator or a general user (attribute).

The detection unit 26 detects the remaining amount of a consumable. In the present embodiment, toner is used as an example of a consumable; however, other consumables may be used likewise. The detection unit 26 detects the remaining amount of toner in decrements of, for example, 1% based on the remaining amount of toner in the toner cartridge and the amount of toner to be used during printing. The detection unit 26 can detect the remaining amount of a consumable such as a lubricant, the degree of wear of a roller, and so forth, in addition to the toner.

The display controller 27 displays a screen in a pop-up form for an administrator or a screen in a pop-up form for a general user when the consumable or the like is in the near end under control of the controller 21. The screen for the administrator differs from the screen for the general user. The operation receiving unit 28 receives an operation of the administrator or the general user on a soft key or a hard key included in the operation panel 940.

FIG. 8 is a table presenting an example of attribute information stored in an attribute information storage unit 31. As illustrated in FIG. 8, an attribute indicating whether the operator is an administrator or a general user is set for each user in the attribute information storage unit 31. Thus, when the operator is identified by the face recognition unit 23 or the authentication processing unit 24, the attribute determination unit 25 can determine whether the logged-in operator is an administrator.

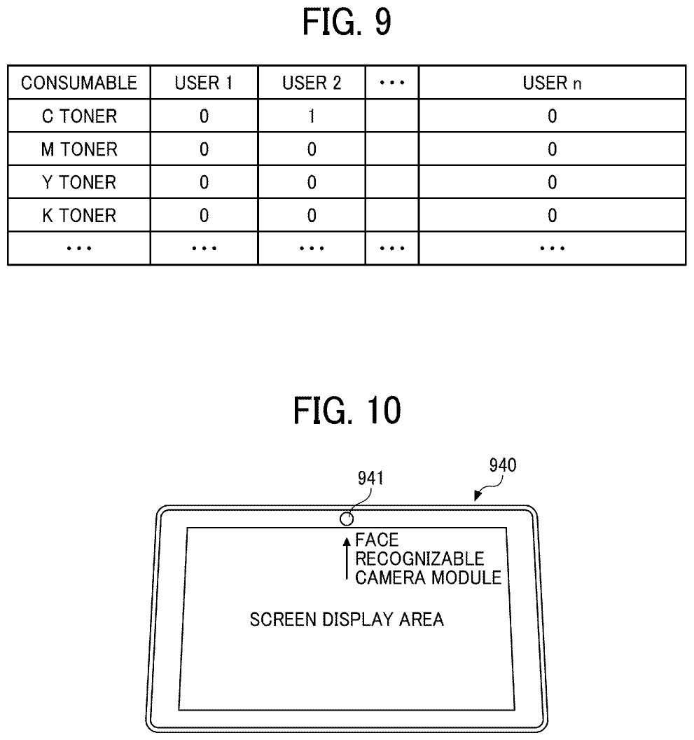

As illustrated in FIG. 9, the controller 21 records that a notification of the near end of a consumable has been made in a notification management information storage unit 32 for each user. The users may include an administrator and a general user. FIG. 9 is a table presenting an example of notification management information stored in the notification management information storage unit 32.

The notification management information is information indicating, for each consumable, whether an operator has been notified of the near end of a consumable. “1” indicates that notification has been made, and “0” indicates that notification has not been made. “1” indicating that the notification has been made is reset to “0” by replenishment or replacement of the consumable. The detection unit 26 can detect replenishment or replacement of the consumable using a sensor detecting attachment or detachment of the cartridge or the like.

Thus, when a certain consumable reaches the near end, the controller 21 determines to notify a general user of the near end of the consumable, to the general user whose information indicating whether the notification has been made is “0”. Even when the information indicating whether the notification has been made is “1” for an administrator, the controller 21 may notify the administrator of the near end of the consumable again. Accordingly, the apparatus 20 can reliably notify the administrator of the near end of the consumable. In one example, the display controller 27 may treat the administrator equivalently to the general user.

### Installation Position of Camera Lens

FIG. 10 is a view illustrating an example of the position of the camera lens 941 included in the camera disposed in the operation panel 940. As illustrated in FIG. 10, the camera lens 941 is installed in a peripheral portion (in an upper portion in FIG. 10) of the operation panel 940. Accordingly, when an administrator or a general user operates the operation panel 940, the face of the administrator or the general user is almost perpendicular to the optical axis of the camera lens 941. The imaging unit 22 easily captures an image of the face of the administrator or the general user from the front using the camera.

When the face recognition unit 23 cannot recognize the face of the administrator or the general user and hence determines that the authentication fails, the controller 21 requests the display controller 27 to display a login screen (described later) by a login method of related art. The display controller 27 displays input fields for a user ID and a password, a request for biometric authentication, a request for login with an IC card, or a combination of these on the operation panel.

### Operations or Processes

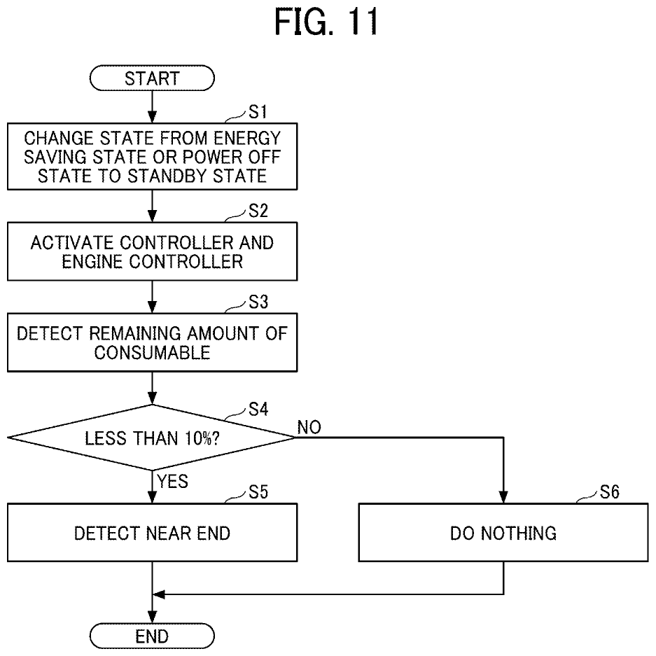

FIG. 11 is a flowchart presenting an example of a process in which the detection unit 26 determines the near end of a consumable.

An administrator or a general user brings the apparatus 20 in the energy saving state or the power off state into a standby state (S1). The standby state is a state in which the apparatus 20 can perform printing. Examples of the method of bringing the apparatus 20 into the standby state include, in addition to power-on, a method in which the administrator or the general user touches the operation panel 940, and a method in which the apparatus 20 receives a print job from the terminal apparatus 40.

By returning to the standby state, the controller 910 and the engine controller 930 are activated (S2).

The detection unit 26 calculates the remaining amount of a consumable (S3). Examples of the consumable include toner, a lubricant, and the amount of wear of a roller belt. The amount of wear of the roller belt may be estimated from the amount of cumulative rotation of the roller belt, or may be actually measured using a sensor or the like.

The detection unit 26 notifies the controller 21 of the remaining amount of the consumable.

The controller 21 determines whether the remaining amount of the consumable is less than a threshold value (for example, 10%) (S4). The threshold value is a value for determining the near end state in which the consumable becomes the end state soon.

When the determination in step S4 is Yes, the controller 21 determines to make a notification of that the consumable is in the near end (S5). Thus, when the administrator or the general user logs in to the apparatus 20, the controller 21 causes the display controller 27 to make the notification of the near end of the consumable.

When the determination in step S4 is No, the controller 21 determines not to make the notification of the near end of the consumable (S6).

The remaining amount of the consumable is detected without exception when the apparatus 20 is activated or returned from the energy saving state. When the apparatus 20 consumes the consumable, the remaining amount of the consumable is detected each time the consumable is consumed (for example, per printing of one page). The operator is notified of the near end of the consumable when the operator logs in to the apparatus 20.

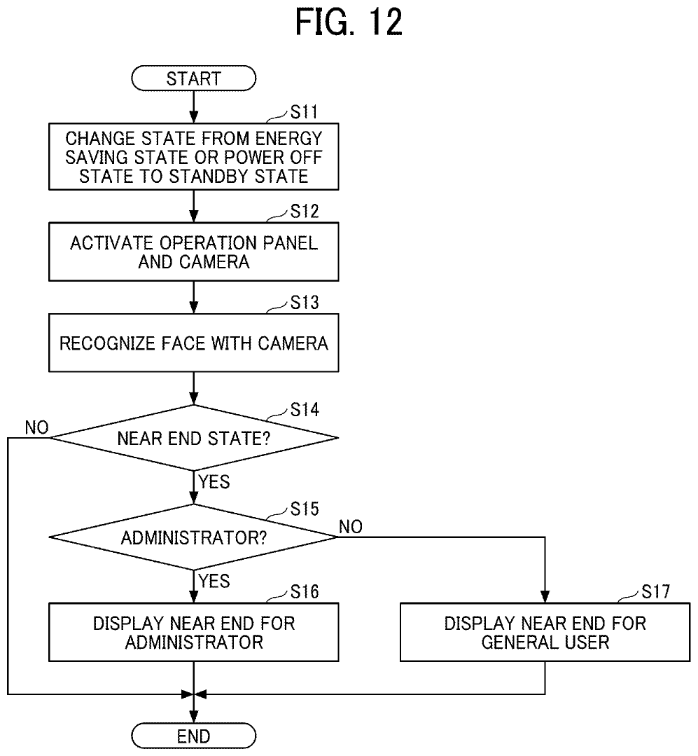

FIG. 12 is a flowchart presenting an example of a process in which the controller 21 performs display relating to the near end of a consumable of the apparatus 20.

An administrator or a general user brings the apparatus 20 into the standby state (S11). The method of bringing the apparatus 20 into the standby state may be similar to that in FIG. 11.

In this case, since the apparatus 20 is in the standby state, the operation panel 940 and the camera disposed in the operation panel 940 are also activated (S12). The imaging unit 22 starts image capturing to repeatedly capture images in the range of the angle of view.

The face recognition unit 23 performs face recognition on the image data captured by the imaging unit 22 (S13). The face recognition unit 23 determines whether the administrator or the general user has been identified as a result of the face recognition, and outputs the user ID or the like to the attribute determination unit 25 when the administrator or the general user has been identified. When the face of the operator has not been registered in the face recognition unit 23, the operator logs in using the user ID and the password.

The face recognition unit 23 learns correspondence between the plurality of images of the face captured by the imaging unit 22 and the user ID input by the operator, thereby recognizing the face at the next login. When the recognition by the face recognition unit 23 is not successful (when a user cannot be identified), the authentication processing unit 24 may authenticate the user using the user ID and the password, the biometric authentication, the IC card, or the like.

The controller 21 determines whether the state is the near end state in accordance with the determination result in FIG. 11 (S14).

When the state is the near end state (Yes in S14), the attribute determination unit 25 determines the attribute of the user ID acquired from the face recognition unit 23 based on the attribute information storage unit 31 (S15). The attribute determination unit 25 outputs the attribute of the operator to the controller 21. When the state is not the near end state (No in S14), the process in FIG. 12 is ended.

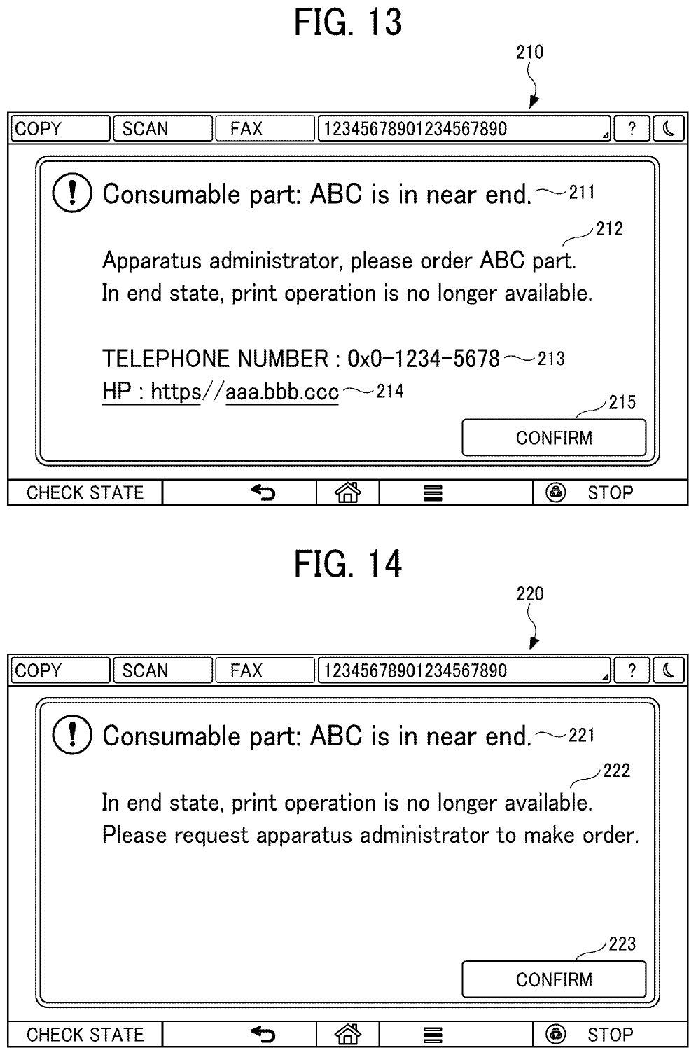

When the operator whose image has been captured by the camera is the administrator (Yes in S15), the controller 21 displays the near end of the consumable on the operation panel 940 for the administrator (S16). FIG. 13 illustrates a display example of the notification in step S16.

When the operator whose image has been captured by the camera is the general user (No in S15), the controller 21 displays the near end of the consumable on the operation panel 940 for the general user (S17). FIG. 14 illustrates a display example of the notification in step S17.

### Display Example of Near End of Consumable

FIG. 13 is a view illustrating an example of a notification screen 210 of the near end of a consumable displayed for an administrator. The notification screen 210 includes a consumable name 211; a message 212 “Apparatus administrator, please order ABC part. In end state, print operation is no longer available.”; a contact information 213, a uniform resource locator (URL) 214 of a reference home page, and a confirmation button 215. The administrator can recognize that the administrator should order the consumable by confirming the message 212.

When the administrator presses the confirmation button 215, the deadline of the order for the consumable and the to-do item may be automatically registered in the schedule (plan) of the administrator. The apparatus 20 is connected to a server on a network, the administrator logs in to a schedule function using the account (ID and password) of the administrator, and registers these items of information.

FIG. 14 is a view illustrating an example of a notification screen 220 of the near end of a consumable displayed for a general user. The notification screen 220 includes a consumable name 221; a message 222 “In end state, print operation is no longer available. Please request apparatus administrator to make order.”; and a confirmation button 223. The general user can recognize that the general user should request the administrator to order the consumable by confirming the message 222.

As apparent from FIGS. 13 and 14, the apparatus 20 can change the notification content of the near end of the consumable depending on whether the operator is the administrator or the general user. Since the notification content for the administrator indicates that the administrator should make the order, the administrator is likely to notice that the administrator should make the order. Since the notification content for the general user indicates that the general user should notify the administrator, the general user is likely to notice that the general user should notify the administrator of the near end of the consumable.

As described above, in the apparatus 20 of the present embodiment, since the pop-up display is provided for the notification of the near end of the consumable that the administrator or the general user could not notice with the warning 201 in one line, it is possible to prevent the apparatus 20 from being difficult to use and downtime from occurring.

The notification contents in FIGS. 13 and 14 are examples, and the messages 212 and 222 are not limited to those illustrated in FIGS. 13 and 14. The message 222 may be, for example, “Please ask administrator about stock of consumable.”, and the message 212 may be, for example, “Please keep certain number of stocks.”

In one example, the apparatus 20 may display the near end of the consumable on a large notification screen 210 for the administrator and display the near end of the consumable on a small notification screen 220 for the general user. In the present embodiment, the usability of the general user can be prevented from being lowered.

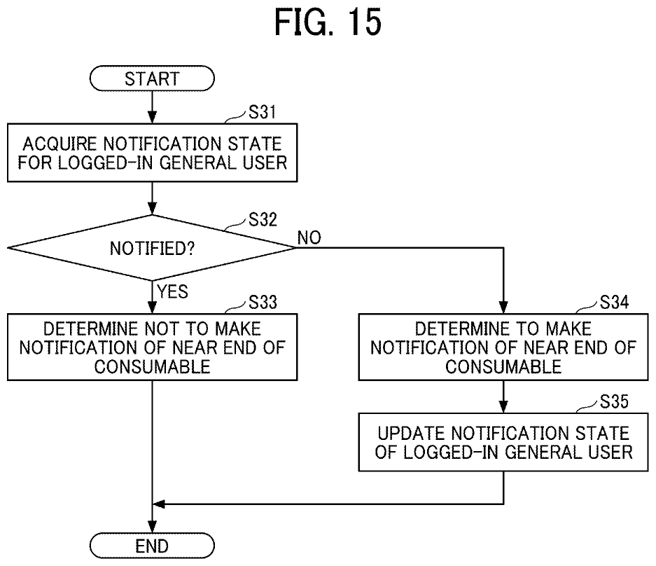

Restriction on Notification of Near End of Consumable for Same General User Restriction on notification of the near end of the consumable for the same general user is described next referring to FIG. 15. When the near end is displayed in a pop-up form for the same consumable many times, the usability of the general user is lowered. Thus, the controller 21 restricts the number of times of notification of the near end of the consumable for the same general user to a predetermined number of times (for example, one time).

FIG. 15 is a flowchart presenting an example of a process in which the controller 21 restricts the notification of the near end of the consumable for the same general user. The process in FIG. 15 is performed in step S17 in FIG. 12 in which the operator has been determined as the general user.

The controller 21 acquires the notification state for the logged-in general user from the notification management information storage unit 32 (S31).

The controller 21 determines whether the logged-in general user has been notified of the near end of the consumable based on the notification management information (S32).

When the determination in step S32 is Yes, the controller 21 determines not to notify the general user of the near end of the consumable (S33).

When the determination in step S32 is No, the controller 21 determines to notify the general user of the near end of the consumable (S34). The controller 21 requests the display controller 27 to display the near end of the consumable, and the display controller 27 displays the near end of the consumable in a pop-up form (FIG. 14).

When the general user presses the confirmation button 223, the controller 21 updates the notification state of the logged-in general user in the notification management information storage unit 32 (S35). That is, the controller 21 sets the flag associated with the logged-in general user to “1”.

Thus, both usability and a reduction in downtime can be attained.

Although the predetermined number of times has been described as one time in FIG. 15, when the predetermined number of times is a plurality of times, the controller 21 records the number of times of notification in the notification management information. In step S32, the controller 21 determines whether the number of times of notification is the predetermined number or more.

When the operator is the administrator, as apparent from the process in FIG. 12, the controller 21 can display the near end of the consumable any number of times.

### Diagram of Screen Transition

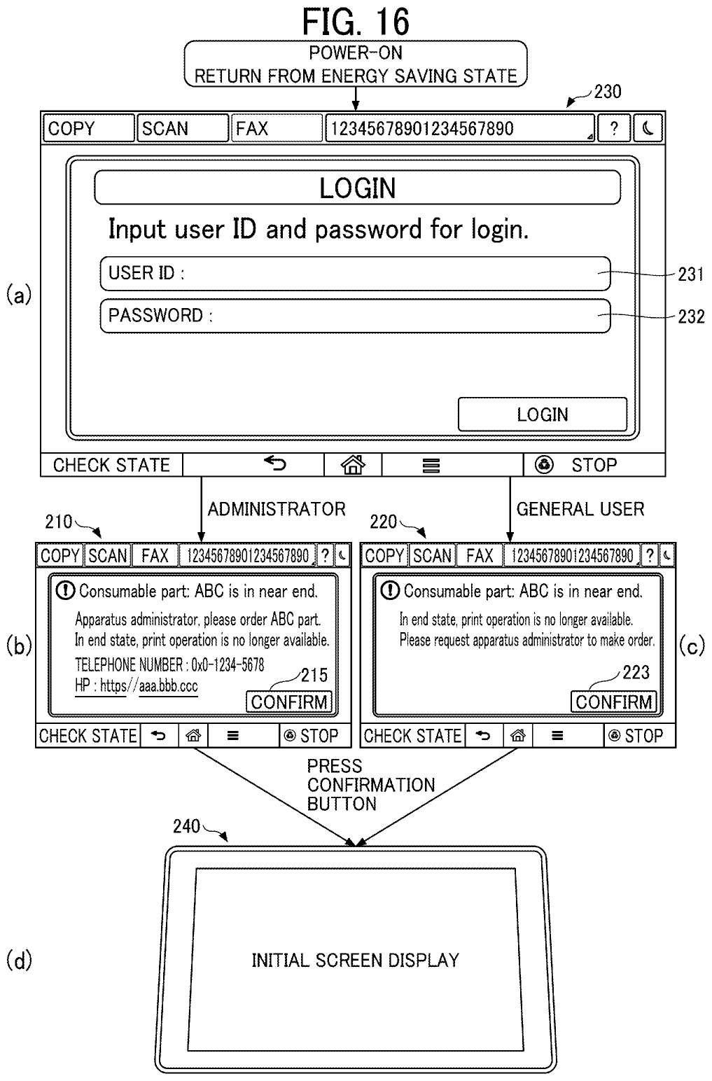

FIG. 16 is a diagram illustrating an example of screen transition of screens displayed by the apparatus 20. FIG. 16(a) illustrates a login screen 230. The login screen 230 includes a user ID field 231 and a password field 232. Since the imaging unit 22 captures an image of the face of an operator while the login screen 230 is displayed, any operator whose image of the face has been registered can log in without the operator inputting the user ID and the password. For an operator whose image of the face has not been registered, the operator inputs the user ID and the password to log in. With the login, the login screen 230 transitions to a notification screen 210 in FIG. 16(b) or a notification screen 220 in FIG. 16(c).

When an administrator logs in, the notification screen 210 illustrated in FIG. 16(b) is displayed. The notification screen 210 is similar to that illustrated in FIG. 13. When a general user logs in, the notification screen 220 in FIG. 16(c) is displayed. The notification screen 220 is similar to that illustrated in FIG. 14.

When the administrator presses the confirmation button 215, the notification screen 210 transitions to an initial screen 240 in FIG. 16(d). When the general user presses the confirmation button 223, the notification screen 220 transitions to the initial screen 240 in FIG. 16(d).

The initial screen 240 varies depending on user setting. The initial screen 240 may be, for example, a screen of a specific application such as a copy application or a scan application, or may be a home screen on which a list of icons of applications is displayed.

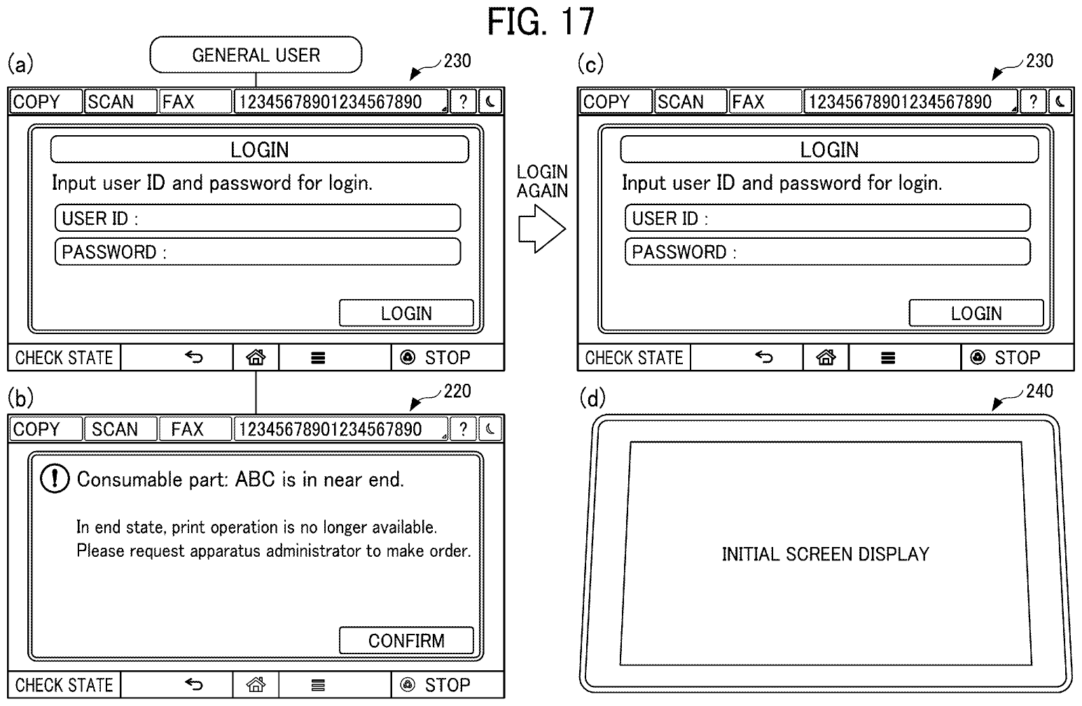

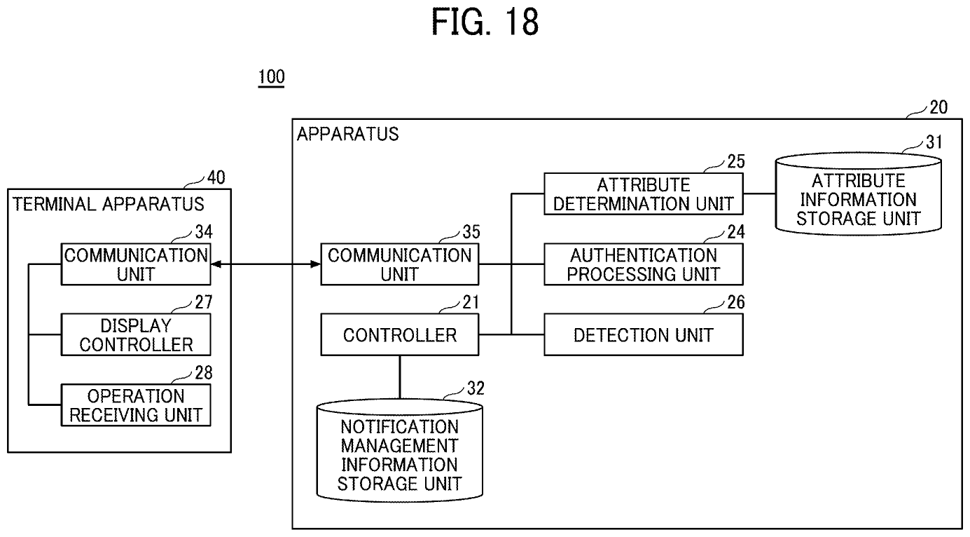

FIG. 17 is a diagram illustrating an example of screen transition when the notification of the near end of the consumable for the same general user is restricted. In the description referring to FIG. 17, a case where the general user has logged in is described.

FIG. 17(a) and FIG. 17(c) illustrate a login screen 230. The login screen 230 is similar to that in FIG. 16(a). FIG. 17(b) illustrates a notification screen 220 displayed when the logged-in general user has not been notified of the near end of the consumable. The notification screen 220 in FIG. 17(b) may be the same as that in FIG. 14.

FIG. 17(d) illustrates an initial screen 240 transitioned from the login screen 230 when the logged-in general user has been notified of the near end of the consumable. The initial screen 240 in FIG. 17(d) may be the same as that in FIG. 16(d).

As described above, since the notification screen 220 is displayed once for the same general user, it is possible to prevent the usability from being lowered.

With the present embodiment, displaying the near end of the consumable in a pop-up form that the administrator or the general user could not notice with the warning in one line can prevent downtime from occurring because the consumable is in the end state. Displaying the near end of the consumable in a pop-up form for the general user leads to lowering usability. However, the apparatus 20 displays the near end of the consumable in a pop-up form once for the general user, thereby preventing the usability from being lowered. Thus, the apparatus 20 of the present embodiment can attain both usability and a reduction in downtime.

### Second Embodiment

In the present embodiment, a terminal apparatus 40 that displays the near end of a consumable when the terminal apparatus 40 and the apparatus 20 communicate with each other via the network N is described. That is, the present embodiment is described based on the system configuration illustrated in FIG. 3B.

In the present embodiment, the description is given based on that the hardware configuration diagrams in FIGS. 5 and 6 described in the above embodiment can be incorporated by reference.

### Functions

FIG. 18 is a block diagram illustrating an example of a functional configuration of an apparatus system 100 in which an apparatus 20 according to the present embodiment and a terminal apparatus 40 that is an information processing apparatus communicate with each other.

### Apparatus

The apparatus 20 includes a communication unit 35, a controller 21, an authentication processing unit 24, an attribute determination unit 25, and a detection unit 26. The functions other than the communication unit 35 may be similar to those in FIG. 7.

The communication unit 35 communicates with the terminal apparatus 40 via a network. The communication unit 35 receives a user ID and a password, and a print job from the terminal apparatus 40. The communication unit 35 transmits a near end notification of a consumable for an administrator when the logged-in operator is an administrator, and transmits a near end notification of a consumable for a general user when the logged-in operator is a general user.

### Terminal Apparatus

The terminal apparatus 40 includes a communication unit 34, a display controller 27, and an operation receiving unit 28.

The functional units included in the terminal apparatus 40 are functions or units that are implemented by the CPU 501 executing commands included in one or more programs installed in the terminal apparatus 40.

The communication unit 34 communicates with the apparatus 20 via the network. The communication unit 34 transmits a user ID and a password, and a print job to the apparatus 20. The communication unit 34 receives a near end notification of a consumable for an administrator when the logged-in operator is an administrator, and receives a near end notification of a consumable for a general user when the logged-in operator is a general user.

The display controller 27, for example, displays the near end notification of the consumable in a pop-up form in a superimposed manner on the screen of a printer driver, or displays the near end notification of the consumable using a desktop notification function.

The operation receiving unit 28 receives various operations of the administrator or the general user on the terminal apparatus 40.

The functional block diagram in FIG. 18 is an example, and the terminal apparatus 40 may include at least one of the authentication processing unit 24, the attribute determination unit 25, and the controller 21. In one example, the terminal apparatus 40 may include an attribute information storage unit 31 and a notification management information storage unit 32.

### Operations or Processes

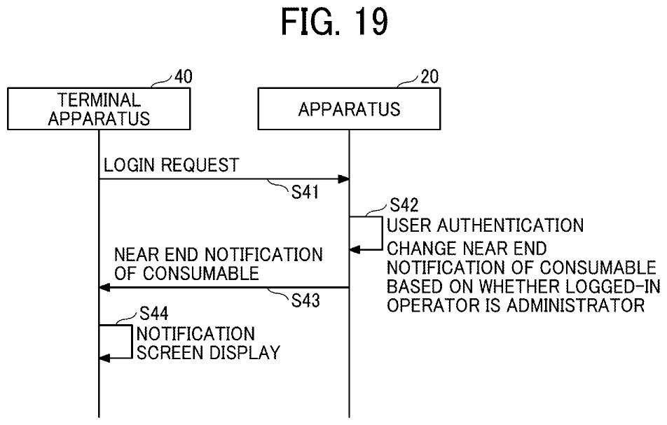

FIG. 19 is a sequence diagram presenting an example of a process in which the terminal apparatus 40 displays a near end notification of a consumable notified from the apparatus 20. In the description referring to FIG. 19, it is assumed that the apparatus 20 has detected the near end of the consumable.

In step S41, an operator performs an operation on the terminal apparatus 40 to log in to the apparatus 20. The communication unit 34 of the terminal apparatus 40 transmits a login request (user ID and password) to the apparatus 20. The method of user authentication in the terminal apparatus 40 may use any of face recognition, biometric authentication, and an IC card. In one example, the terminal apparatus 40 may transmit the user ID to the apparatus 20 when the operator logs in to the terminal apparatus 40. That is, the apparatus 20 may omit the authentication process.

In step S42, the communication unit 35 of the apparatus 20 receives the login request. The controller 21 performs a process of changing the near end notification of the consumable based on the user authentication and whether the logged-in operator is an administrator similarly to the first embodiment. The controller 21 restricts the notification of the near end of the consumable for the same general user.

In step S43, the communication unit 35 of the apparatus 20 transmits the near end notification of the consumable that differs depending on whether the logged-in operator is an administrator to the terminal apparatus 40.

In step S44, the communication unit 34 of the terminal apparatus 40 receives the near end notification of the consumable, and the display controller 27 displays the near end notification of the consumable.

### Screen Example

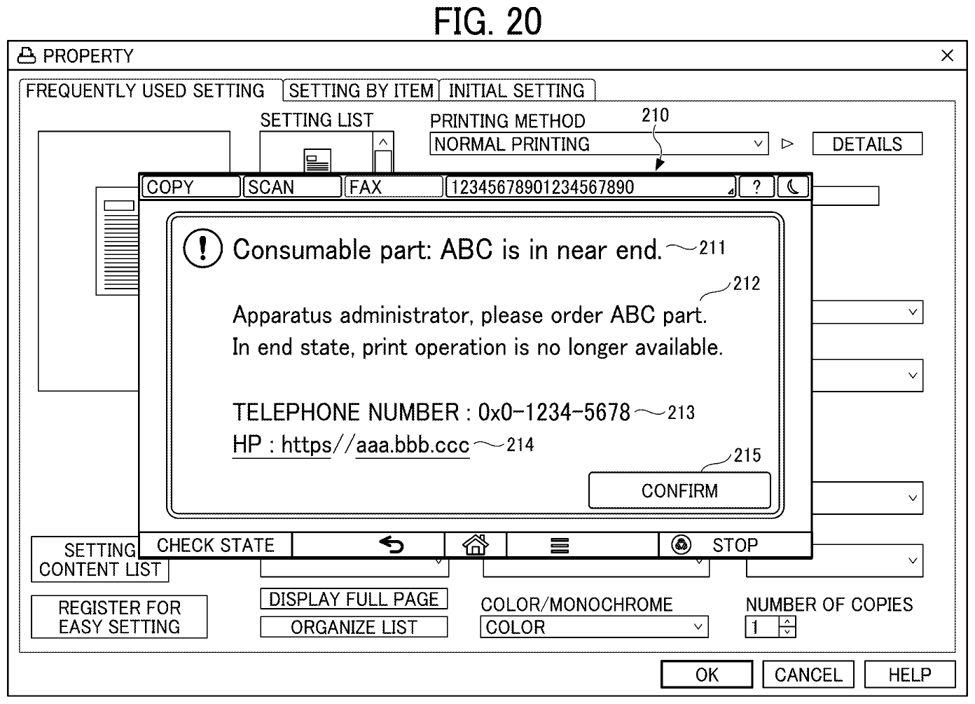

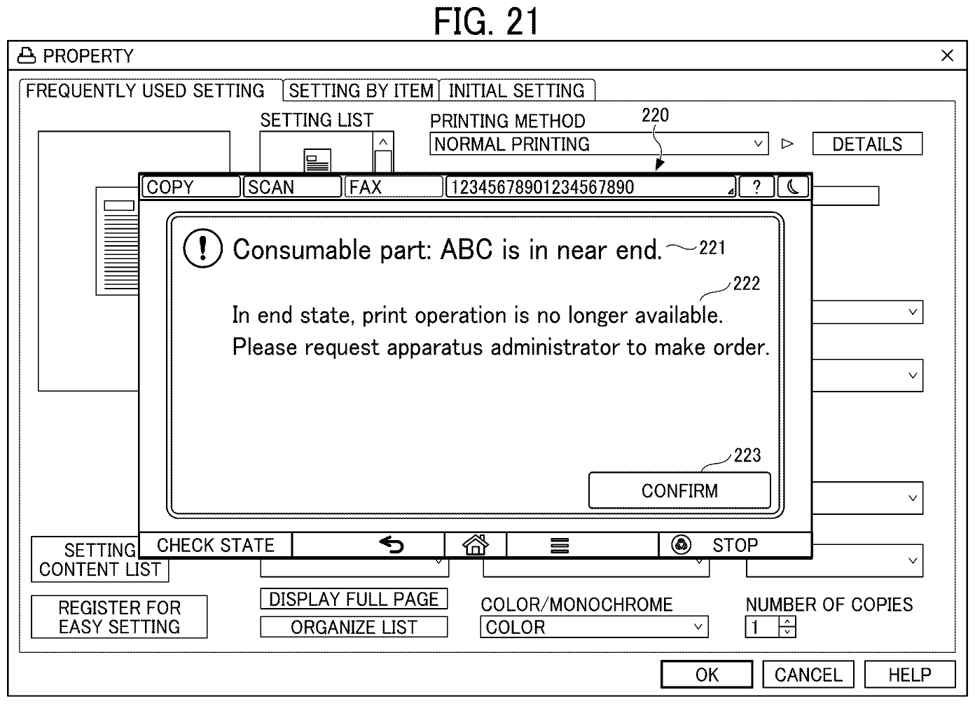

FIG. 20 illustrates a notification screen 210 displayed in a pop-up form in a superimposed manner on a printer driver displayed by the terminal apparatus 40 when the logged-in operator is an administrator. FIG. 21 illustrates a notification screen 220 displayed in a pop-up form in a superimposed manner on the printer driver displayed by the terminal apparatus 40 when the logged-in operator is a general user. The notification screens 210 and 220 in FIGS. 20 and 21 may be the same as those displayed by the apparatus 20. When the administrator or the general user presses a confirmation button 215 or 223, the pressing of the confirmation button 215 or 223 is transmitted to the apparatus 20 and is stored in the notification management information storage unit 32.

The display methods in FIGS. 20 and 21 are examples, and the near end of the consumable may be displayed in part of items of the printer driver. For example, the display controller 27 may change a toner cartridge of an illustration imitating the shape of the apparatus 20 to a form indicating the near end, or may blink the toner cartridge in an emphasis color such as red.

With the present embodiment, in addition to the advantageous effect of the first embodiment, even when the operator uses the terminal apparatus 40, the terminal apparatus 40 can display the near end of the consumable.

### Third Embodiment

In the present embodiment, an apparatus system 100 when an apparatus 20 is an industrial robot or a three-dimensional (3D) printer is described.

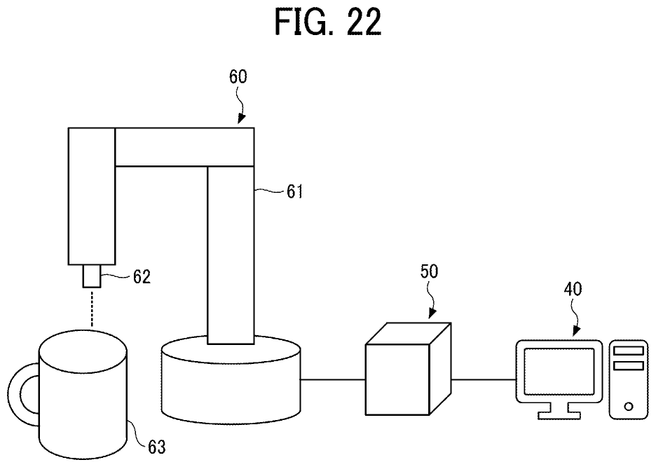

FIG. 22 illustrates a three-dimensional object forming system as a configuration example of an apparatus system 100 according to the present embodiment.

The apparatus system (three-dimensional object forming system) 100 includes a three-dimensional object image forming apparatus 60, a robot control apparatus 50 as an information processing apparatus, and a terminal apparatus 40 as an information processing apparatus. The three-dimensional object image forming apparatus 60 and the robot control apparatus 50 are communicably connected to each other by wire or radio. The robot control apparatus 50 and the terminal apparatus 40 are communicably connected to each other by wire or radio.

The three-dimensional object image forming apparatus 60 is an apparatus that controls a robot 61 to form an image on a surface of a three-dimensional object 63 by an inkjet method. The three-dimensional object image forming apparatus 60 includes the robot 61 and a liquid discharge unit 62. The robot 61 may be a multi-joint arm or the like, and can direct a liquid discharge head of the liquid discharge unit 62 in a desirable direction.

The liquid discharge unit 62 includes the liquid discharge head that discharges ink that is an example of liquid toward the three-dimensional object 63. The robot 61 repeats a process of slightly changing the discharge destination each time ink is discharged to change the formation position of the image on the three-dimensional object 63. The robot 61 may drive the arm to change the discharge destination, or may rotate a turntable when the three-dimensional object 63 is placed on the turntable.

The three-dimensional object image forming apparatus 60 includes a sensor that detects the remaining amount of ink and a sensor that detects the worn states of various parts.

The terminal apparatus 40 receives an instruction from an operator, and generates image data for forming an image on the three-dimensional object 63. The terminal apparatus 40 transmits the generated image data to the robot control apparatus 50. The robot control apparatus 50 generates a control instruction for controlling the robot 61 based on the received image data, and transmits the control instruction to the three-dimensional object image forming apparatus 60.

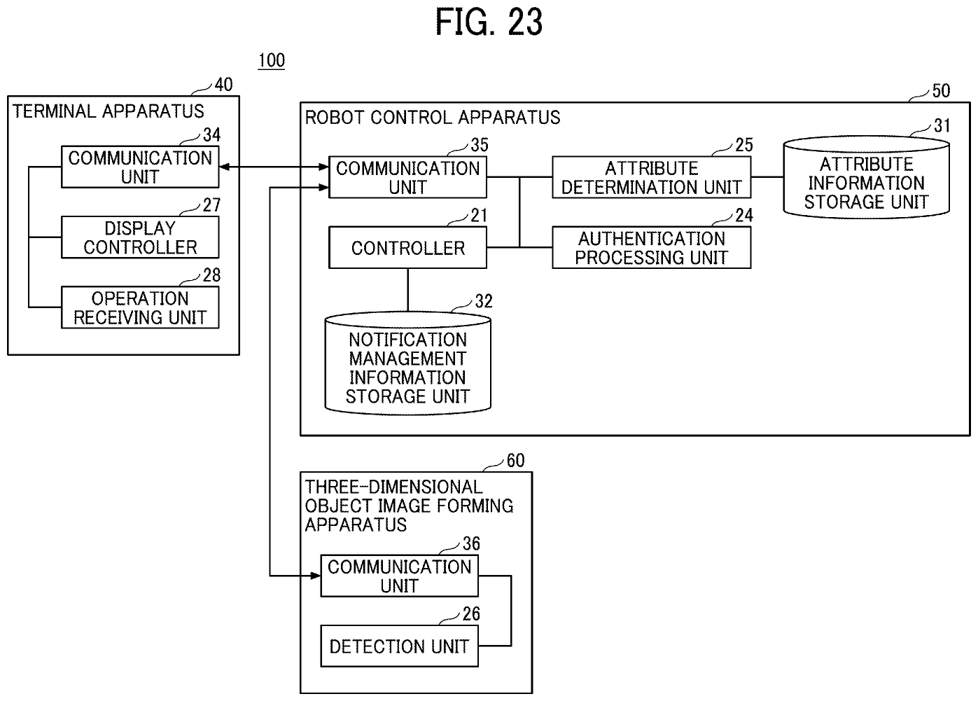

FIG. 23 is a functional block diagram illustrating an example of a functional configuration of the apparatus system 100 in FIG. 22. The three-dimensional object image forming apparatus 60 includes a communication unit 36 and a detection unit 26. The function of the detection unit 26 may be similar to that in the second embodiment. The communication unit 36 transmits the near end of a consumable detected by the detection unit 26 to the robot control apparatus 50.

The robot control apparatus 50 has functions equivalent to those of the communication unit 35, the controller 21, the attribute determination unit 25, and the authentication processing unit 24 described referring to FIG. 18 of the second embodiment. The robot control apparatus 50 changes the notification content of the near end of the consumable to be transmitted to the terminal apparatus 40 in accordance with whether the logged-in operator is an administrator.

The terminal apparatus 40 has functions equivalent to the functions of the communication unit 34, the display controller 27, and the operation receiving unit 28 described referring to FIG. 18 of the second embodiment. The terminal apparatus 40 displays the notification screen received from the robot control apparatus 50.

In one example, the terminal apparatus 40 may perform the authentication process for the operator. In this case, the terminal apparatus 40 includes a device (a keyboard, a camera, an IC card reader, a biometric authentication device, or the like) for performing the authentication of the operator, and performs user authentication without requiring an authentication server. In one example, the terminal apparatus 40 may transmit authentication information to an external server and acquire an authentication result. The communication unit 34 of the terminal apparatus 40 transmits the user ID of the logged-in operator to the robot control apparatus 50. The robot control apparatus 50 determines the attribute of the operator (whether the operator is an administrator or a general user).

In one example, the robot control apparatus 50 may detect the near end of a consumable instead of the three-dimensional object image forming apparatus 60. In one example, the terminal apparatus 40 may determine whether the operator is an administrator. In one example, control may be performed to record, for each user, that the terminal apparatus 40 has made a notification of the near end of a consumable in the notification management information storage unit 32. As described above, any of the robot control apparatus 50, the terminal apparatus 40, and the three-dimensional object image forming apparatus 60 may have the functions illustrated in FIG. 23.

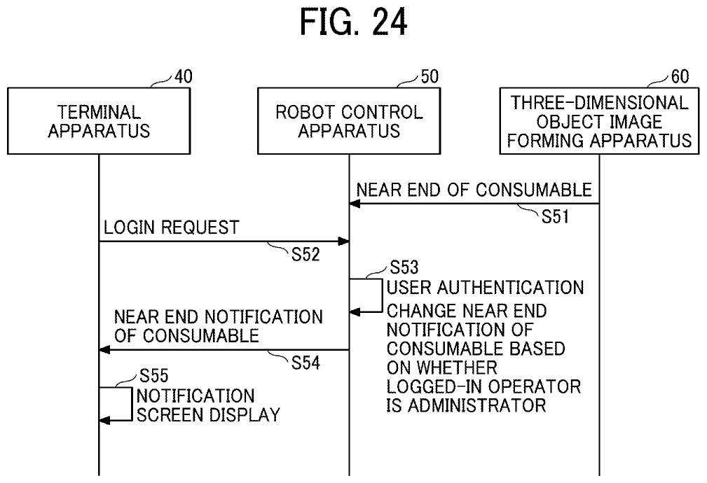

FIG. 24 is a sequence diagram presenting an example of a process in which the terminal apparatus 40 displays a near end notification of a consumable notified from the robot control apparatus 50. Points different from those in FIG. 19 are mainly described referring to FIG. 24.

In step S51, when the detection unit 26 of the three-dimensional object image forming apparatus 60 detects the near end of a consumable, the robot control apparatus 50 is notified of the near end of the consumable.

The process from step S52 to step S55 is similar to that in FIG. 19. Notification screens 210 and 220 displayed by the terminal apparatus 40 may be similar to those in the first embodiment (FIGS. 13 and 14) or the second embodiment (FIGS. 20 and 21).

### Apparatus System Using 3D Printer

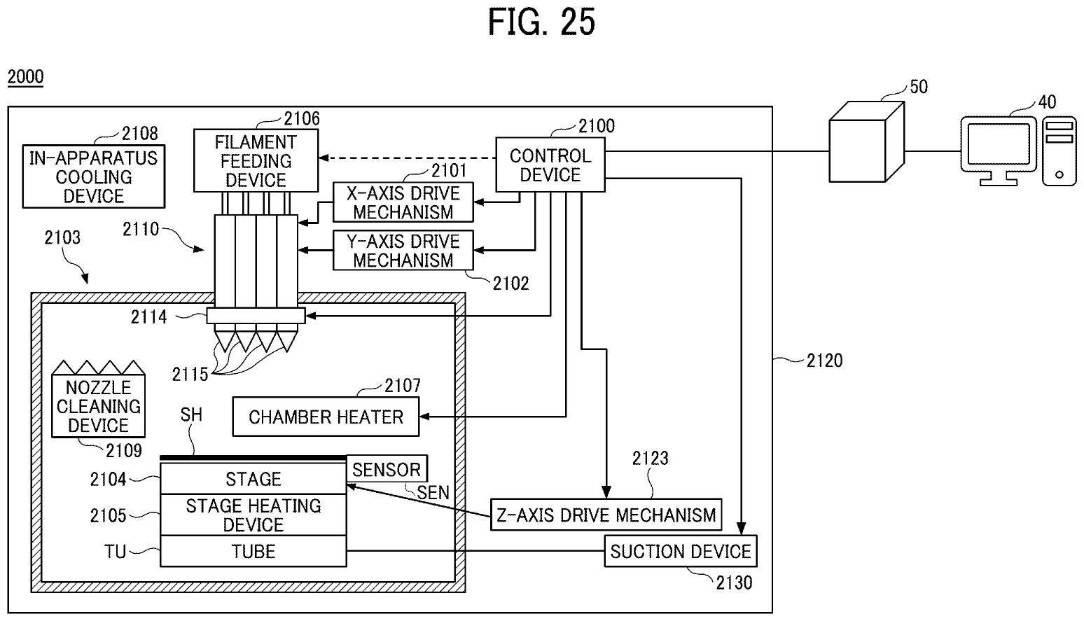

As illustrated in FIG. 25, the apparatus system 100 according to the present embodiment is also suitably applicable to a 3D printer. FIG. 25 is a diagram illustrating an example of a configuration of an apparatus system 100 when a 3D printer is employed. In FIG. 25, the configurations of a robot control apparatus 50 and a terminal apparatus 40 may be similar to those in FIG. 22. In the case of the 3D printer in FIG. 25, the consumable is, for example, a filament that becomes a shaped object.

As illustrated, a 3D printer 2000 includes a chamber 2103 in a main body frame 2120. The inside of the chamber 2103 serves as a processing space for three-dimensionally shaping an object to be shaped. In the processing space, that is, in the chamber 2103, a stage 2104 is provided as a mounting table. In this example, a shaped object is manufactured on the stage 2104.

In the chamber 2103, a shaping head 2110 serving as a shaping unit is provided above the stage 2104. The shaping head 2110 has a discharge nozzle 2115 disposed below the shaping head 2110. The discharge nozzle 2115 discharges a filament. The discharge nozzle 2115 includes four discharge nozzles 2115 provided on the shaping head 2110 in this embodiment. However, the number of discharge nozzles 2115 is any number. The shaping head 2110 includes a head heating device 2114 that heats the filament fed to each of the discharge nozzles 2115. As described above, the 3D printer manufactures a shaped object using the filament held in advance.

The temperature of the inside of the main body frame 2120 is adjusted by an in-apparatus cooling device 2108.

The filament is made of, for example, a material such as acrylonitrile butadiene styrene (ABS) resin or polylactic acid (PLA) resin. The filament is thermoplastic. Thus, the filament is heated and is at a high temperature when discharged from the 3D printer. After the discharge, the filament is cooled by, for example, air cooling and then solidified. Using such a characteristic, the 3D printer discharges the filament to manufacture a shaped object.

The filament has, for example, a narrow and long wire shape. The filament in a wound state or the like is set in the 3D printer 2000. A filament feeding device 2106 feeds the filament to each of the discharge nozzles 2115 provided on the shaping head 2110.

The shaping head 2110 is moved in the X-axis direction by an X-axis drive mechanism 2101. For example, the X-axis drive mechanism 2101 includes an actuator, a mechanism, a power supply, and an electronic circuit.

Likewise, the shaping head 2110 is moved in the Y-axis direction by a Y-axis drive mechanism 2102. For example, the Y-axis drive mechanism 2102 includes an actuator, a mechanism, a power supply, and an electronic circuit. The stage 2104 is moved in the Z-axis direction by a Z-axis drive mechanism 2123. In the present embodiment, the Z-axis drive mechanism 2123 includes, for example, an actuator, power source, electric circuit, and other mechanism.

For example, the Z-axis drive mechanism 2123 includes an actuator, a mechanism, a power supply, and an electronic circuit.

In the illustrated example, a control device 2100 instructs the position to the X-axis drive mechanism 2101, the Y-axis drive mechanism 2102, and the Z-axis drive mechanism 2123. Each of the X-axis drive mechanism 2101, the Y-axis drive mechanism 2102, and the Z-axis drive mechanism 2123 moves the shaping head 2110 and the stage 2104 to the instructed position based on the instruction from the control device 2100. The control device 2100 controls each device.

As illustrated, the 3D printer 2000 desirably includes the stage 2104 and a stage heating device 2105 that can heat a shaped object on the stage 2104. The stage heating device 2105 is, for example, a heater.

A chamber heater 2107 is provided in the chamber 2103 (processing space), as a heating unit that heats the inside of the chamber 2103. The 3D printer 2000 desirably performs manufacturing in a state in which the temperature in the chamber 2103 is maintained at a target temperature by the chamber heater 2107.

Different types of filaments or the same type of filament may be used for the discharge nozzles 2115. In the present embodiment, the 3D printer 2000 heats and melts the filament fed from the filament feeding device 2106 using the head heating device 2114.

Then, the 3D printer 2000 extrudes the filament in a molten state from the discharge nozzle 2115 and discharges the filament. The 3D printer 2000 stacks layers formed of the filament on the stage 2104 by the discharge to manufacture a shaped object.

The 3D printer 2000 may be an apparatus using a support material. That is, the support material may be fed to the discharge nozzle 2115. The support material may be a material different from the filament. After the manufacturing, the support material is removed from the shaped object formed of the filament. For example, the support material is first heated and molten by the head heating device 2114 similarly to the filament. Then, the support material in a molten state is discharged from the discharge nozzle 2115 so as to be extruded, and is stacked similarly to the filament.

As illustrated, the 3D printer 2000 desirably has a configuration that can suck a sheet SH placed on the stage 2104. For example, as illustrated, the sheet SH is sucked by a tube TU and a suction device 2130 based on the state detected by a sensor SEN.

As illustrated, the 3D printer 2000 desirably includes a nozzle cleaning device 2109. The nozzle cleaning device 2109 cleans the discharge nozzle 2115 to prevent impurities and the like from being mixed with the discharged filament.

Thus, the 3D printer 2000 performs a preheating process of raising the temperature in the chamber 2103 to the target temperature in advance before the start of manufacturing. For example, the chamber heater 2107 heats the inside of the chamber 2103 to raise the temperature of the inside of the chamber 2103 to a temperature near the target temperature during the preheating process. During manufacturing, the chamber heater 2107 heats the inside of the chamber 2103 to maintain the temperature of the inside of the chamber 2103 at a temperature near the target temperature. The operation of the chamber heater 2107 is controlled by the control device 2100.

The hardware configuration of the 3D printer 2000 is not limited to the illustrated hardware configuration. In one example, the control device 2100 or the like may have a plurality of hardware configurations. In one example, the 3D printer 2000 may have a hardware configuration without the suction device 2130 or the like.

With the present embodiment, in addition to the advantageous effect of the first embodiment, for the consumable of the industrial robot or the 3D printer, the robot control apparatus 50 can change the notification content of the near end of the consumable in accordance with whether the operator is an administrator.

### Variations

While the present disclosure has been described above using one or more embodiments, the one or more embodiments do not limit the present disclosure in any way. Various modifications and replacements may be made within a scope not departing from the gist of the present disclosure.

For example, while the apparatus 20 displays the near end of the consumable on the operation panel 940 for both the administrator and the general user, the apparatus 20 may change the notification method of the near end of the consumable depending on whether the operator is the administrator or the general user. For example, when the operator is the administrator, the apparatus 20 notifies the administrator of the near end of the consumable by email. When the operator is the general user, the apparatus 20 displays the near end of the consumable on the operation panel 940 for the general user. The apparatus 20 may transmit an email to the administrator in addition to the display on the operation panel 940.

While the apparatus 20 determines whether the logged-in operator is the administrator or the general user in the present embodiment, the operator does not have to log in as long as the attribute of the operator is identified.

That is, processing up to the authentication process does not have to be executed as long as the operator is recognized.

When the administrator does not log in for a certain period since the near end of the consumable is detected, or when the consumable is not replaced although the administrator logs in, the apparatus 20 may notify the general user of the same notification content as that of the administrator. The apparatus 20 can detect that the administrator does not replenish the consumable, and change the notification content, for example, during a long vacation of the administrator.

While the apparatus 20 determines whether the operator is the administrator or the general user in the present embodiment, the apparatus 20 may further determine an attribute such as an administrative user who plays a role between the administrator and the general user. The apparatus 20 can notify the administrative user of a notification content different from those of the administrator and the general user in the near end of the consumable. The apparatus 20 notifies the administrative user of, for example, “Please order toner on behalf of administrator.”

While the notification content of the near end of the consumable is changed in accordance with the attribute of the operator in the present embodiment, information relating to the apparatus 20 may be changed in accordance with the attribute of the operator and notified. Examples of the information relating to the apparatus 20 include a schedule of maintenance. The maintenance refers to keeping an apparatus in a normal state. The maintenance is also referred to as aftercare. The maintenance includes cleaning and repair in addition to replenishment and replacement of consumables.

When the maintenance schedule comes close, the apparatus 20 displays a message “Mm/dd/yyyy is scheduled date of maintenance. Please check stock of parts to be used.” to the logged-in administrator. When the maintenance schedule comes close, the apparatus 20 displays a message “There is time period not available because of maintenance on mm/dd/yyyy. Please contact administrator for details.” to the logged-in general user.

While the notification screen is changed in accordance with the attribute of the operator in the present embodiment, the content of a voice message may be changed in accordance with the attribute of the operator.

While the image forming apparatus is described as an example of the apparatus 20 in the present embodiment, the apparatus 20 may be any apparatus that uses a consumable. Examples of the apparatus 20 include a projector (a consumable being a light bulb), an electronic whiteboard (a consumable being a battery of a pen for handwriting on the electronic whiteboard), digital signage (operating on a battery, a consumable being the battery), a drone (a consumable being a battery), and a mobile robot (a consumable being a battery). The battery is desirably a secondary battery, and there are a use form in which a battery is replaced with another battery, and a use form in which two or more batteries are prepared and a discharged battery is replaced with a charged battery.

The examples of the configurations like ones illustrated in FIGS. 7, 18, and 23 are divided into blocks in accordance with main functions for easier understanding of the processing by the terminal apparatus 40, the apparatus 20, the robot control apparatus 50, and the three-dimensional object image forming apparatus 60. The disclosure of the present application is not limited by the method of dividing the units of processing or the names of the processing. The processing of the terminal apparatus 40, the apparatus 20, the robot control apparatus 50, and the three-dimensional object image forming apparatus 60 can be divided into more units of processing in accordance with the content of the processing. One unit of processing may be divided so as to include more sub-units of processing.

The apparatuses described in one or more embodiments are just one example of multiple computing environments that implement the one or more embodiments disclosed herein. In some embodiments, the information processing system 10 includes multiple computing devices, such as a server cluster. The multiple computing devices communicate with one another through any type of communication link including a network, a shared memory, or the like and perform the processes disclosed in the present specification.

Each of the functions in the one or more embodiments described above may be implemented by one or more processing circuits or circuitry. Here, the “processing circuit” in the present specification includes a processor programmed to execute each function by software such as a processor implemented by an electronic circuit, and a device such as an application specific integrated circuit (ASIC), a digital signal processor (DSP), a field programmable gate array (FPGA), or a conventional circuit module designed to execute each function described above.

In related art, there is a concern that a consumable is not ordered at proper timing and downtime occurs. The apparatus has the function of detecting the near end of the consumable and displaying the near end. However, when the administrator or the general user does not notice the display, for example, the consumable may be ordered after the consumable becomes the end state in which the consumable is completely used up. For example, even when it is displayed that the consumable is in the near end, the administrator or the general user may be unnoticed of the display. A long period of downtime may occur although the consumable is ordered with notice after the consumable is used up. However, even when the apparatus displays the near end for the administrator and the general user similarly, the general user has difficulty in properly dealing with this situation.

According to the one or more embodiments described above, by displaying the notification content relating to the state of the consumable in accordance with the operator of the apparatus, it is possible to effectively prevent downtime of the apparatus from occurring.

### Aspect 1

According to Aspect 1, an apparatus includes a displaying unit, and receives an operation of an operator. The apparatus includes a detection unit that detects a state of a consumable that is used in the apparatus, an attribute determination unit that determines an attribute of the operator, and a display controller that changes a notification content relating to the state of the consumable in accordance with the attribute of the operator determined by the attribute determination unit and displays the notification content on the displaying unit.

### Aspect 2

According to Aspect 2, in the apparatus of Aspect 1, the attribute of the operator is one of an administrator or a general user of the apparatus, and the display controller changes the notification content relating to the state of the consumable in accordance with whether the operator is the administrator or the general user and displays the notification content on the displaying unit.

### Aspect 3

According to Aspect 3, in the apparatus of Aspect 2, the state of the consumable is that a remaining amount of the consumable is less than a threshold value, and the display controller displays a notification content indicating that the administrator should order the consumable on the displaying unit when the operator is the administrator, and displays a notification content indicating that the general user should request the administrator to order the consumable on the displaying unit when the operator is the general user.

### Aspect 4

According to Aspect 4, in the apparatus of Aspect 2 or Aspect 3, when the operator is the general user, the display controller displays the notification relating to the state of the consumable on the displaying unit a predetermined number of times for the same consumable.

### Aspect 5

According to Aspect 5, the apparatus of Aspect 4 further includes a controller. In a case where the display controller displays the notification relating to the state of the consumable on the displaying unit for the general user and receives confirmation from the general user, the controller records that the notification relating to the state of the consumable has been provided in notification management information in association with the consumable and the general user. When the operator is the general user, the controller determines whether the notification relating to the state of the consumable has been displayed on the displaying unit the predetermined number of times based on the notification management information.

### Aspect 6

According to Aspect 6, in the apparatus of any one of Aspect 2 to Aspect 5, when the operator is the administrator, the display controller displays the notification relating to the state of the consumable on the displaying unit each time the administrator logs in.

### Aspect 7

According to Aspect 7, in the apparatus of any one of Aspect 1 to Aspect 6, the operator is authenticated based on biometric authentication information acquired from the operator.

### Aspect 8

According to Aspect 8, the apparatus of any one of Aspect 1 to Aspect 6 further includes an imaging unit, and a face recognition unit that recognizes the operator based on an image of a face of the operator who operates the apparatus, the image being captured by the imaging unit.

### Aspect 9

According to Aspect 9, in the apparatus of Aspect 7, the attribute determination unit determines the attribute of the operator who has been successful in the authentication by the authentication processing unit based on attribute information in which the attribute of the operator is associated with the operator.

### Aspect 10

According to Aspect 10, in the apparatus of any one of Aspect 1 to Aspect 9, the apparatus is an image forming apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An apparatus comprising:
a display; and
circuitry configured to
receive operation from an operator,
determine an attribute of the operator, and
display on the display a notification content relating to a state of a consumable that is used in the apparatus in accordance with the attribute of the operator.

2. The apparatus according to claim 1,
wherein the attribute of the operator is one of an administrator or a general user of the apparatus, and
wherein the circuitry is configured to display the notification content on the display in accordance with the attribute of the operator indicating whether the operator is the administrator or the general user.

3. The apparatus according to claim 2,
wherein the state of the consumable indicates that a remaining amount of the consumable is less than a threshold value, and
wherein the circuitry is configured to
display on the display a notification content prompting the administrator to order the consumable in a case where the operator is the administrator, and
display on the display a notification content prompting the general user to request the administrator to order the consumable in a case where the operator is the general user.

4. The apparatus according to claim 2, wherein, in the case where the operator is the general user,
the circuitry is configured to display on the display the notification content relating to the state of the consumable a predetermined number of times for the same consumable.

5. The apparatus according to claim 4, wherein, in a case where the circuitry displays on the display the notification content relating to the state of the consumable for the general user and receives confirmation from the general user,
the circuitry is configured to record, in notification management information, information indicating that the notification content relating to the state of the consumable has been transmitted in association with the consumable and the general user, and
wherein, in the case where the operator is the general user,
the circuitry is configured to determine whether the notification content relating to the state of the consumable has been displayed on the display the predetermined number of times based on the notification management information.

6. The apparatus according to claim 2, wherein, in the case where the operator is the administrator,
the circuitry is configured to display on the display the notification content relating to the state of the consumable each time the administrator logs in.

7. The apparatus according to claim 1, wherein the circuitry is configured to authenticate the operator based on biometric authentication information acquired from the operator.

8. The apparatus according to claim 1, further comprising:
an imaging device,
wherein the circuitry is configured to recognize the operator based on an image of a face of the operator captured by the imaging device.

9. The apparatus according to claim 7, wherein the circuitry is configured to determine the attribute of the operator who has been successful in the authentication based on attribute information in which the attribute of the operator is associated with the operator.

10. The apparatus according to claim 1, further comprising:
an image forming device that forms an image.

11. A system comprising:
an apparatus that uses a consumable; and
an information processing apparatus to communicate with the apparatus and receive an operation of an operator on the apparatus,
wherein the apparatus includes:
a display; and
circuitry configured to
determine an attribute of the operator, and
display on the display a notification content relating to a state of the consumable that is used in the apparatus in accordance with the attribute of the operator.

12. The system according to claim 11, wherein the apparatus further comprises:
an image forming device to print an image on a surface of a three-dimensional object.

13. A non-transitory recording medium storing a plurality of instructions which, when executed by one or more processors, causes the one or more processors to perform a display method, the method comprising:
receiving operation from an operator;
determining an attribute of the operator; and
displaying on a display a notification content relating to a state of a consumable that is used in the apparatus in accordance with the attribute of the operator.
